(19) United States
(12) Patent Application Publication
(10) Pub. No.: US 2013/0343627 A1
(43) Pub. Date: Dec. 26, 2013

(54) SUPPRESSION OF REVERBERATIONS AND/OR CLUTTER IN ULTRASONIC IMAGING SYSTEMS

(71) Applicant: CRYSTALVIEW MEDICAL IMAGING LIMITED, CHANNEL ISLANDS (GB)

(72) Inventor: Gil ZWIRN, Petach-Tikva (IS)

(73) Assignee: CRYSTALVIEW MEDICAL IMAGING LIMITED, Channel Islands (GB)

(21) Appl. No.: 13/916,528

(22) Filed: Jun. 12, 2013

(30) Foreign Application Priority Data
Jun. 13, 2012 (GB) 1210438.6

(51) Int. Cl. G06T 5/00

(52) U.S. Cl. CPC G06T 5/002
USPC 382/131

(57) ABSTRACT

There is provided a method for reverberation and/or clutter suppression in ultrasonic imaging, comprising: computing similarity measures between voxels within a cine-loop or subset of the cine-loop, to assess their spatial and/or temporal self-similarity; for at least one of: (i) each voxel; (ii) each group of adjacent voxels within the cine-loop or subset of the cine-loop; and (iii) each group of voxels which are determined to be affected by reverberations and/or clutter, based on one or more criteria; computing one or more reverberation and/or clutter parameters; and for at least one of: (i) each voxel; (ii) each group of adjacent voxels within the cine-loop or subset of the cine-loop; and (iii) each group of voxels which are determined to be reverberation and/or clutter affected voxels, based on one or more criteria, applying reverberation and/or clutter suppression using the corresponding reverberation and/or clutter suppression parameters.

This application claims the benefit of UK Patent Application No. GB1210438.6 filed Jun. 13, 2012, which is hereby incorporated by reference.

### FIELD OF THE INVENTION

The present invention relates generally to ultrasonic imaging systems, e.g., for medical imaging, and particularly to methods and systems for suppressing reverberation and/or clutter artifacts in ultrasonic imaging systems.

### BACKGROUND OF THE INVENTION

Ultrasonic medical imaging plays a crucial role in modern medicine, gradually becoming more and more important as new developments enter the market. One of the most common ultrasound imaging applications is echocardiography, or ultrasonic imaging of the cardiac system. Other widespread applications are obstetrics and gynecology, as well as abdominal imaging, to name a few. Ultrasonic imaging is also used in various other industries, e.g., for flaw detection during hardware manufacturing.

Ultrasonic imaging systems typically produce relatively noisy images, making the analysis of these images a task for highly trained experts. One of the common imaging artifacts, degrading the image quality, is multiple reflections of the transmitted ultrasound pulse, a phenomenon often referred to as reverberations or multi-path. When transmitting an ultrasound pulse into a target volume, the pulse may be partially transmitted and partially reflected, or even fully reflected, at interfaces between regions with different acoustic impedance (“acoustic interfaces”), thus producing reflected signals. A reflected signal may hit another acoustic interface on its way back to the probe, where it may be partially transmitted and partially reflected, or even fully reflected. The result of a reflected signal being reflected at least once again, either partially or fully, within a target volume is referred to herein as a reverberation signal. The net effect of the aforementioned multiple reflections is that in addition to the original pulse, there are one or more reverberation signals traveling into the target volume, which may generate ghost images of objects located in other spatial locations (“reverberation artifacts”). The ghost images may be sharp, but they may also be hazy when the acoustic interfaces are small and distributed.

Reverberation artifacts may be categorized a being a part of a group of imaging artifacts called clutter. The term “clutter” refers to undesired information that appears in the imaging plane or volume, obstructing data of interest. Clutter artifacts also include, for example, sidelobe clutter, i.e., reflections received from the probe's sidelobes. Sidelobe clutter which results from highly reflective elements in the probe's sidelobes may have energy levels which are comparable to or even higher than those of reflections originating from the probe's mainlobe, thus having significant adverse effects on the information content of ultrasound images.

An exemplary illustration for reverberation artifacts can be seen in FIGS. 2A and 2B. In FIG. 2A, an object 50 includes two parallel reflective layers, 51 and 52. A probe 60 is pressed to object 50, transmitting ultrasound pulses in multiple directions, each of which is referred to as a “scan line”, as customary in B-scan mode. Some exemplary ultrasound wave paths for a scan line which is perpendicular to the reflective layers 51 and 52 are shown as dotted lines 61, 62, 63 and 65. In one such ultrasound wave path, the wave follows a straight line 61 toward reflective layers 51 and 52, and is reflected first by layer 51 and then by layer 52, to produce reflected waves 62 and 63 respectively. In another ultrasound wave path 65, the wave follows a straight line toward reflective layer 51, and is reflected from layer 51, then from the surface of probe 60, and finally from layer 51 again, to be received as a reverberation signal by probe 60. The resulting B-scan image is seen in FIG. 2B. Reflective layers 51 and 52 are mapped to line segments 71 and 72 in image 70, whereas diffuse lines 75 and 76 result from reverberations.

Another exemplary illustration for reverberation artifacts can be seen in FIGS. 3A and 3B. FIG. 3A includes an object 80 with a highly reflective layer 81, and a circular reflective surface 82. A probe 90 is pressed to object 80, operating in B-scan mode. Some exemplary ultrasound wave paths are shown as dotted lines 91, 92 and 93. Wave path 91 corresponds to a direct wave path from probe 90 to circular reflective surface 82, wherein the wave is reflected towards probe 90. Waves path 92 and 93 correspond to a reverberation signal, wherein a wave is reflected from reflective layer 81, then from circular reflective surface 82, and finally from reflective layer 81 again, to be received by probe 90. The resulting B-scan image is seen in FIG. 3B. Reflective layers 81 is mapped to line segment 101 in image 100, circular reflective surface 82 is mapped to circle 102 in image 100, and circle 105 in image 100 is a reverberation ghost of circular reflective surface 82.

In medical imaging, the multiple reflections between tissue structures are in many cases so weak that their effect on the image is negligible, but reflections from highly reflective structures, such as bones and cartilage, do sometimes produce observable reverberation artifacts. Furthermore, when pressing the probe to a surface, there are often strong reflections near the surface of the probe, due to the large difference in acoustic impedance between the probe material and the tissue (even when using an ultrasound gel). This may result in strong reverberation signals, e.g., due to multiple reflections between subcutaneous fat layers and the probe (“reverberations from the probe's face”).

One method known in the art for reducing reverberations is using harmonic imaging instead of fundamental imaging, i.e., transmitting ultrasonic signals at a certain frequency and receiving at a frequency which equals an integer number times the transmitted frequency. e.g., receiving at a frequency twice as high as the transmitted frequency. Spencer et al. describe this method in a paper entitled “Use of harmonic imaging without echocardiographic contrast to improve two-dimensional image quality,” American Journal of Cardiology, vol. 82, 1998, pages 794-799, which is incorporated herein by reference.

Other methods for reducing reverberations are based on adjusting the ultrasound probe design, e.g., using a convex shaped probe, which causes the reflections from the probe's face to be scattered. Japanese patent application 3032652, by Takayoshi and Yasushi, published on Feb. 13, 1991, titled “Ultrasonic probe,” discloses a method and system for reducing the multipath reflection generated at the interface between an ultrasound probe and a body to be examined, based on minimizing the acoustic impedance difference and the sound speed variation between the probe and the body to be examined. This is done by placing suitable liquid within the probe.

Further methods for reducing reverberations employ processing of the signal received by different elements of the transducer array comprising the ultrasound probe. U.S. Pat. No. 4,471,785, by Wilson et al., issued on Sep. 18, 1984, titled “Ultrasonic imaging system with correction for velocity inhomogeneity and multipath interference using an ultrasonic imaging array,” discloses an ultrasonic imaging system wherein a cross-correlator is used to compare the signals received by various elements of the transducer array. An output addressing circuit is connected to inhibit or otherwise modify gain of signals of selected transducer array elements, to reduce multipath ultrasonic wave interference, refraction or obstruction image distortion or degradation.

Even further methods for reducing reverberations are based on altering the ultrasound probe's scanning method and/or pattern. U.S. Pat. No. 4,269,066, by Fischer, issued on May 26, 1981, titled “Ultrasonic sensing apparatus,” discloses an ultrasound scanning apparatus, wherein the ultrasound transducers are mounted for rotation in an off-axis configuration. With this configuration, transmission and reception of sound occurs without the sound being normal to the membrane contacting the body. This reduces reverberation artifacts and permits viewing shallow tissue with a relatively small apparatus European patent application 1327892, by Roundhill et al., published on Jul. 16, 2003, titled “Ultrasonic image scanning apparatus and method,” discloses a method for scanning an image field with ultrasound pulses, which are transmitted and received in a plurality of beam directions extending spatially adjacent to each other over the image field from one lateral extreme to an opposite lateral extreme for minimizing multipath artifacts. The method comprises: sequentially transmitting and receiving beams in successive beam directions along which the consecutively transmitted and received beams are substantially separated in space, in an alternate manner. U.S. Pat. No. 5,438,994, by Starosta et al., issued on Aug. 8, 1995, titled “Ultrasonic diagnostic image scanning,” discloses a technique for scanning an image field with adjacent ultrasound beams in which initially transmitted beams are transmitted along beam directions down the center of the image field. Subsequent beams are alternately transmitted on either side of the initially transmitted beams and at increasing lateral locations until the full image has been scanned. In a preferred embodiment, a waiting period is added to the pulse repetition interval of each transmission, to allow time for multipath reflections to dissipate. The waiting periods are longer during initial transmissions in the vicinity of the image field center, and decline as beams are transmitted in increasing lateral locations of the field.

Other methods for reducing reverberations utilize multiple receive beams, multiple transmission pulses and/or complex waveforms for each of the probe's scan lines. European patent application 2287632, by Angelsen et al., published on Feb. 23, 2011, titled “Ultrasound imaging using non-linear manipulation of forward propagation properties of a pulse.” discloses methods for ultrasound imaging with reduced reverberation noise and other artifacts, based on processing the echoes received from transmitted dual frequency band ultrasound pulse complexes with overlapping high and low frequency pulses. The high frequency pulse is used for image reconstruction, and the low frequency pulse is used to manipulate the non-linear scattering and/or the propagation properties of the high frequency pulse. U.S. patent application 2003/0199763, by Angelsen and Johansen, published on Oct. 23, 2003, titled “Corrections for pulse reverberations and phase-front aberrations in ultrasound imaging,” discloses a method of correcting for pulse reverberation in ultrasound imaging using two-dimensional transducer arrays. In a first embodiment, the pulse reverberation is estimated by two transmit events, where the second event is determined by measurement and processing on measurement on echoes of the first event. In a second embodiment, the reverberation is estimated by a single transmit event, using two receive beams and processing on them. In a third embodiment, the reverberation from very strong scatterers is reduced by adjustment of the active transmit aperture. U.S. Pat. No. 5,465,723, by Angelsen and Nickel, issued on Nov. 14, 1995, titled “Method and apparatus for ultrasound imaging,” discloses a method and apparatus wherein two pulses are emitted by an ultrasound transducer along a beam propagation direction against an object to be imaged. The second pulse has a transducer-to-object propagation time greater than the first pulse, the propagation time difference being achieved by selectively varying the effective or acoustic distance between the transducer and the object. The received echoes of the second pulse are time-shifted as a function of the propagation time difference and subtracted from the echoes of the first pulse, thereby reducing from the resulting signal, reverberation echoes between the transducer and the object. Chinese utility model 201200425, by Zheng et al., published on Mar. 4, 2009, titled “Ultrasound scanning probe,” discloses an ultrasonic scanning probe including two ultrasonic transducers, which are fixed on the same scanning plane, and have different transmitting distances and are respectively matched with two groups of independent exciting and receiving circuits. The reverberation artifact caused by multiple reflections can be eliminated for the two groups of obtained back waves through waveform translation, time-delay and multiplication processes so as to improve the ultrasound imaging quality. PCT application WO2011/001310, by Vignon et al., published on Jan. 6, 2011, titled “Propagation-medium-modification-based reverberated-signal elimination,” discloses an apparatus and method for correcting acquired echo data to reduce content from ultrasound that has undergone at least one reflection off the probe surface, for example, to reduce reverberation artifacts. In some embodiments, the propagation medium through which the reverberation occurs, i.e., layer or adjoining layers through which the reverberation occurs, is modified after acquiring an echo dataset in preparation for the next application of ultrasound. During the next application, the reverberation ultrasound signals are more affected by the modification than are the non-reverberating, direct signals. This difference is due, for example, to greater overall time of flight through the modified medium on account of reverberation in the propagation path. U.S. Pat. No. 6,436,041, by Phillips and Guracar, issued on Aug. 20, 2002, titled “Medical ultrasonic imaging method with improved ultrasonic contrast agent specificity,” discloses a method comprising transmitting a set of ultrasonic pulses including at least two pulses that differ in at least one of amplitude or phase, acquiring a set of receive signals in response to the set of ultrasonic pulses, and combining the set of receive signals. The method further comprises transmitting at least one reverberation suppression pulse prior to the aforementioned set of ultrasonic pulses, each reverberation suppression pulse characterized by an amplitude and phase selected to suppress acoustic reverberations in the combined set of receive signals.

Additional methods for reducing reverberations employ spatial filtering of acquired ultrasound images. U.S. Pat. No. 5,524,623, by Liu, issued on Jun. 11, 1996, titled “Adaptive artifact suppression for ultrasound imaging,” discloses a method for reducing reverberation artifacts in ultrasound images, wherein an ultrasound image includes an ordered array of pixels with defined axial and lateral directions. The method starts by dividing the image into a plurality of segmentation blocks, thereby generating an ordered array of segmentation blocks, wherein the columns are chosen such that all segmentation blocks on the same column correspond to the same axial direction in the ultrasound image. The method finds a first segmentation block that is classified as a strong edge, and then finds a second segmentation block which is not classified as a strong edge in the column containing the first segmentation block. A spatial frequency domain transformned block is then generated from a processing block containing the second segmentation block, and a modified transformed block is generated from the spatial frequency domain transformed block by reducing the amplitude of selected peaks in the transformed block. Finally, a new second segmentation block is generated by computing the inverse spatial frequency transform of the modified transform block.

### SUMMARY OF THE INVENTION

Embodiments of the present invention provide methods and devices for reducing reverberation and/or clutter artifacts in ultrasonic imaging systems.
According to a first aspect of the invention, there is provided a method for reverberation and/or clutter suppression in ultrasonic imaging, said method comprising:
   transmitting an ultrasonic radiation towards a target medium via a probe (26);
   receiving reflections of the ultrasonic radiation from said target medium in a reflected signal via a scanner (22), wherein the reflected signal is spatially arranged in a scanned data array, which may be one-, two-, or three-dimensional, so that each entry into the scanned data array corresponds to a pixel or a volume pixel (collectively “voxel”), and wherein the reflected signal may also be divided into frames, each of which corresponding to a specific timeframe is a cine-loop;
said method being characterized by the following:
   step 110—computing one or more similarity measures between two or more voxels or groups of voxels within a cine-loop or within a processed subset of the cine-loop, so as to assess their spatial and/or temporal self-similarity, wherein the processed subset of the cine-loop is defined by a set of entries into the scanned data array for all frames and/or for a set of the cine-loop frames and/or for a set of entries into the scanned data array for each of a set of frames;
   step 120—for at least one of: (i) each voxel; (ii) each group of adjacent voxels within the cine-loop or the processed subset of the cine-loop; and (iii) each group of voxels which are determined to be affected by reverberations and/or clutter, based on one or more criteria, at least one of which relates to the similarity measures computed in step 110.
computing one or more reverberation and/or clutter parameters, at least one of which also depends on the similarity measures computed in step 110; and
   step 130—for at least one of: (i) each voxel; (ii) each group of adjacent voxels within the cine-loop or the processed subset of the cine-loop; and (iii) each group of voxels which are determined to be reverberation and/or clutter affected voxels, based on one or more criteria, at least one of which relates to the similarity measures computed in step 110,
applying reverberation and/or clutter suppression using the corresponding reverberation and/or clutter suppression parameters.

Other aspects of the present invention are detailed in the claims.

### BRIEF DESCRIPTION OF THE DRAWINGS

The invention for suppression of reverberation and/or clutter in ultrasonic imaging systems is herein described, by way of example only, with reference to the accompanying drawings. With specific reference now to the drawings in detail, it is emphasized that the particulars shown are by way of example and for purposes of illustrative discussion of the embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1A is a schematic, pictorial illustration of an ultrasonic imaging system, in accordance with an embodiment of the present invention;

FIG. 1B is a schematic, pictorial illustration of a probe used in an ultrasonic imaging system, in accordance with an embodiment of the present invention;

FIG. 2A is a schematic, pictorial illustration of a scanned object that may produce reverberation signals, in accordance with an embodiment of the present invention;

FIG. 2B is a schematic, pictorial illustration of a B-scan image of the scanned object shown in FIG. 2A, in accordance with an embodiment of the present invention;

FIG. 3A is a schematic, pictorial illustration of a scanned object that may produce reverberation signals, in accordance with an embodiment of the present invention;

FIG. 3B is a schematic, pictorial illustration of a B-scan image of the scanned object shown in FIG. 3A, in accordance with an embodiment of the present invention; and

FIG. 4 is a flow-chart describing the main processing steps in a reverberation and/or clutter suppression process, in accordance with an embodiment of the present invention.

### DETAILED DESCRIPTION OF THE DRAWINGS

### System Description

In broad terms, the present invention relates to methods and systems for suppressing reverberation and/or clutter effects in ultrasonic imaging systems.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

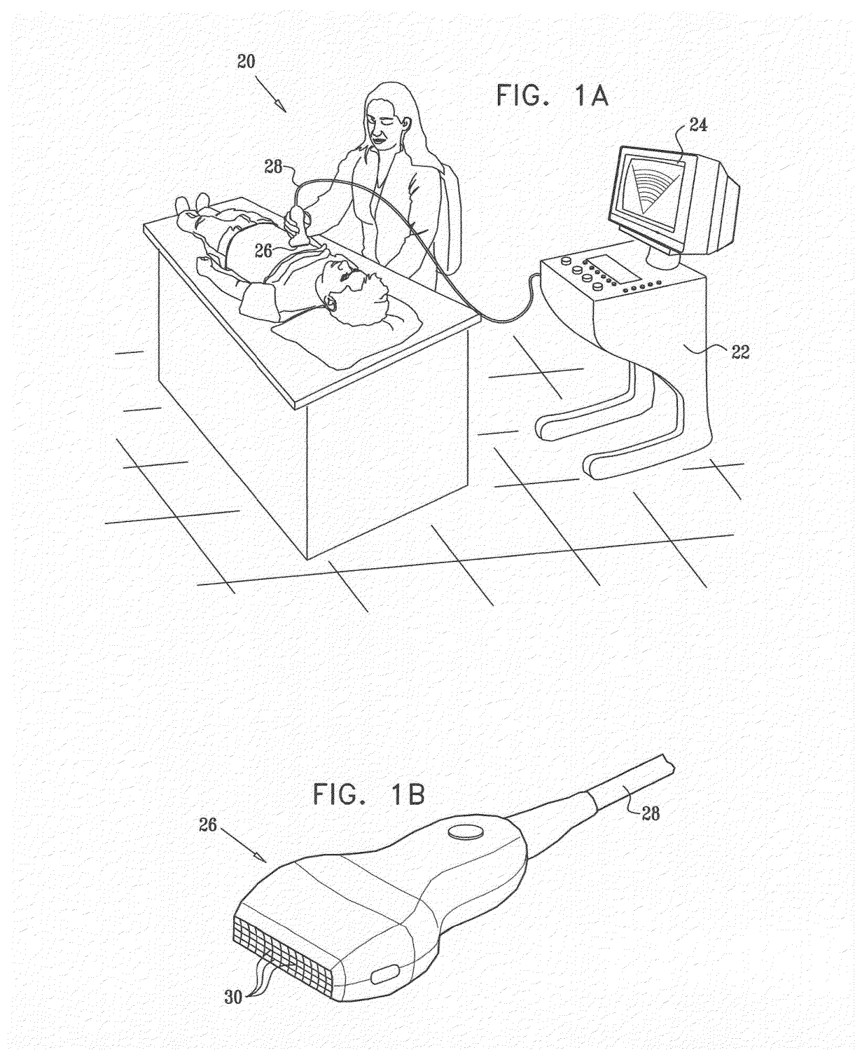

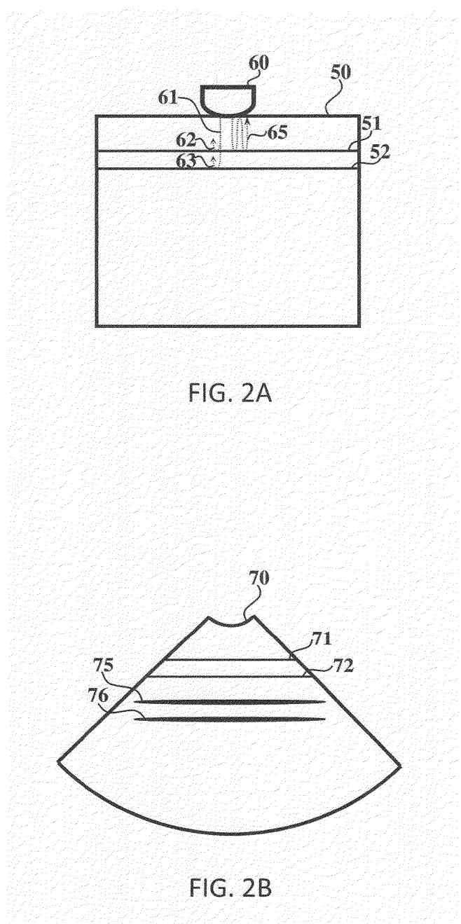

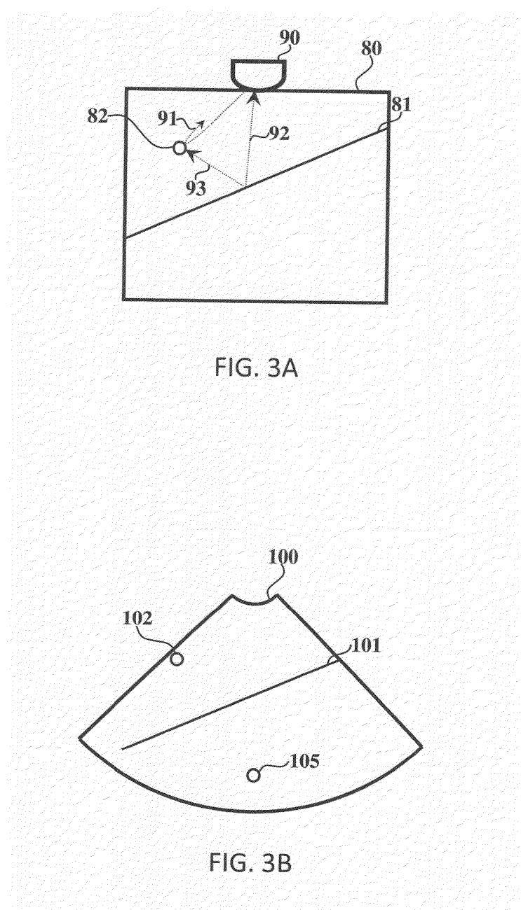

FIG. 1A is a schematic, pictorial illustration of an ultrasonic imaging system 20, in accordance with an embodiment of the present invention. System 20 comprises an ultrasound scanner 22, which scans using ultrasound radiation a target region, e.g., in medical applications, organs of a patient. A display unit 24 displays the scanned images. A probe 26, connected to scanner 22 by a cable 28, is typically positioned in close proximity to the target region. For example, in medical applications, the probe may be held against the patient body in order to image a particular body structure, such as the heart (referred to as a “target” or an “object”); alternatively, the probe may be adapted for insertion into the body, e.g., in transesophageal, transvaginal, or intravascular configurations. The probe transmits and receives ultrasound beams required for imaging. Scanner 22 comprises control and processing circuits for controlling probe 26 and processing the signals received by the probe.

FIG. 1B is a schematic, pictorial illustration of probe 26 used in imaging system 20, in accordance with an embodiment of the present invention. In an exemplary configuration of probe 26, it comprises an array of transducers 30, e.g., piezoelectric transducers, which are configured to operate as a phased array, allowing electronic beam steering. On transmission, the transducers convert electrical signals produced by scanner 22 into a beam of ultrasound radiation transmitted into the target region. On reception, the transducers receive the ultrasound radiation reflected from different objects within the target region, and convert it into electrical signals sent to scanner 22 for processing. In embodiments, probe 26 may further comprise mechanisms for changing the mechanical location and/or orientation of the array of transducers 30, which may include one or more transducers, so as to allow mechanical steering of the beam of ultrasound radiation, either in addition to or in place of the electronic beam steering.

### Acquired Data Arrangement

Scanner 22 may be operated so that probe 26 would scan a one-dimensional (1D), two-dimensional (2D) or three-dimensional (3D) target region. The target region may be scanned once, or where required or desired, the target region may be scanned multiple times, at certain time swaths, wherein the acquired data corresponding to each scan is commonly referred to as a frame. A set of consecutive frames acquired for a target region at a specific timeframe is referred to as a cine-loop.

The reflected signal measured by probe 26 may be described as a set of real or complex measurements, each of which corresponds to a certain volume covered by a scan line, between consecutive iso-time surfaces of the ultrasound wave within the medium (with respect to the probe 26), typically but not necessarily matching constant time intervals. Each such volume is commonly referred to as a volume pixel, or voxel. The samples are commonly referred to as range-gates, since in many cases the speed of sound does not change significantly while traversing the target region (e.g., the speed of sound within different soft tissues is quite similar), so that iso-time surfaces can approximately be referred to as iso-range surfaces.

The target region may be scanned by probe 26 using any scanning pattern and/or method known in the art. For example, different scan lines may have the same phase center but different directions in such cases, a polar coordinate system is typically used in 2D scanning, and a spherical coordinate system is typically used in 3D scanning. When using a polar coordinate system, the location of each voxel may be defined by the corresponding range-gate index and the angular direction of the scan line with respect to the broadside of probe 26, wherein the probe's broadside is defined by a line perpendicular to the surface of probe 26 at its phase center, and wherein said angular direction may be defined in a Euclidian space by an azimuth angle, and/or by the u coordinate in sine-space. Similarly, when using a spherical coordinate system, the location of each voxel may be defined by the corresponding range-gate index and the angular direction of the scan line with respect to the broadside of probe 26, wherein the angle direction may be defined either by the azimuth and elevation angles and/or by the (u,v) coordinates in sine-space. Other coordinate systems may be appropriate for different scanning patterns.

The target region may be scanned using a certain coordinate system (“scanning coordinate system”), e.g., polar or spherical, but then the acquired data is then converted to a different coordinate system (“processing coordinate system”), e.g., Cartesian coordinates. Such coordinate system transformations may be utilized so as to match the standard coordinate system of common display units 24, and/or to facilitate further processing. The coordinate system transformation may be performed by spatial interpolation and/or extrapolation, using any method known in the art, e.g., nearest neighbor interpolation, linear interpolation, spline or smoothing spline interpolation, and so forth.

Regardless of the scanning method and coordinate system used, the dataset collected per frame may be organized in a 1D, 2D or 3D array (“scanned data array”), using any voxel arrangement known in the art, wherein each index into the scanned data array relates to a different axis (e.g., in a polar coordinate system, a range-gate index and an azimuth index may be utilized), so that voxels which are adjacent to each other in one or more axes of the coordinate system also have similar indices in the corresponding axes. The coordinate system used by the scanned data array may match the scanning coordinate system or the processing coordinate system.

Unless otherwise defined, the term “signal” or “ultrasound signal” herein may refer to the data in any processing phase of scanner 22, e.g., to an analog signal produced by scanner 22, to real or complex data produced by analog-to-digital converter or converters of scanner 22, to videointensities to be displayed, or to data before or after any of the following processing steps of scanner 22: (i) filtration of the received signal using a filter matched to the transmitted waveform; (ii) down-conversion of the received signal, bringing its central frequency to an intermediate frequency or to 0 Hz (“baseband”); (iii) gain corrections, such as overall gain control and time-gain control (TGC); (iv) log-compression, i.e., computing the logarithm of the signal magnitude; and (v) polar formatting, i.e., transforming the dataset to a Cartesian coordinate system. Furthermore, the term “signal energy” herein may be interpreted as the squared signal magnitude and/or the signal magnitude and/or a function of the signal magnitude and/or the local videointensity.

Reverberation and/or Clutter Suppression Method

In the following description, various aspects of the present invention are described. The reverberation and/or other clutter artifacts in ultrasound images are detected and/or suppressed employing techniques searching for spatial and/or temporal self-similarity. In that context, two or more groups of voxels, corresponding to different sets of entries into the scanned data array and/or to different frames, are similar if the signal pattern within the two or more groups of voxels is similar, either in their original spatial orientation or after applying spatial rotation (the computation process associated with spatial rotation should take into account the coordinate system of the scanned data array) and/or mirror reversal, defined herein as the reversal of the signal pattern along a certain axis (which may or may not correspond to any axis of the scanning coordinate system or the processing coordinate system).

Two or more signal patterns are considered similar if the signal ratio between most or all of the pairs of voxels within one pattern is similar to the signal ratio of the corresponding pairs of voxels in the other patterns, wherein the term “signal ratio” may refer to one of: (i) the ratio of the measured signals, using any scale known in the art, e.g., linear scale; (ii) the ratio of the magnitudes of the measured signals, using any scale known in the art, e.g., linear scale or logarithmic scale; (iii) the energy ratio of the measured signals, using any scale known in the art, e.g., linear scale or logarithmic scale; or (iv) the ratio of videointensities of the corresponding voxels. Similarity between patterns may be assessed using any operator known in the art (referred to hereinatter as “similarity measures”), e.g. correlation coefficient, mean square error applied to normalized voxel groups, sum absolute difference applied to normalized voxel groups, and so forth, wherein normalized voxel groups are voxel groups that have been multiplied by a factor that equalizes the value of a certain statistical property of all applicable voxel groups, wherein the statistical property may be, for example, the mean, median, maximum and so on. When searching for similarity between patterns, one can, for example, use a kernel whose spatial and/or temporal dimensions are predefined. Another example would be to use multiple kernel sizes and multi-scale processing. A further example would be to use any segmentation method known in the art so as to determine the boundaries of one or more selected elements within a frame, e.g., continuous elements whose mean signal energy is high, which may produce discernible reverberation and/or clutter artifacts, and then for each selected element determine the spatial dimensions of the kernel used to search for similar elements in accordance with the selected element's dimensions.

In embodiments of the present invention, wherein spatial rotations are also considered, the kernel dimensions may also take into account the maximal expected rotation of each selected element. Additionally or alternatively, one may transform various spatial regions in various frames into a feature space, using any feature space known in the art, and compare the regions in terms of their description in the feature space. In some embodiments, the set of features used for the feature space may be invariant to spatial translation and/or spatial rotation and/or mirror reversal. The scale invariant feature transform (SIFT), described by Lowe in a paper entitled “Object recognition from local scale-invariant features,” The Proceedings of the Seventh IEEE International Conference on Computer Vision, vol. 2, 1999, pages 1150-1157, and/or variations thereof, may be utilized as well.

Two or more similar groups of voxels are considered herein as self-similar if they belong to the same cine-loop. The term “spatial self-similarity” is used when the two or more similar groups of voxels correspond to different sets of entries into the scanned data array, either in the same frame or in different frames of the cine-loop. The term “temporal self-similarity” is used when the two or more similar groups of voxels correspond to different firames of the cine-loop. The term “spatial-temporal self-similarity” is used when the two or more similar groups of voxels correspond to different sets of entries into the scanned data array, and to different frames of the cine-loop.

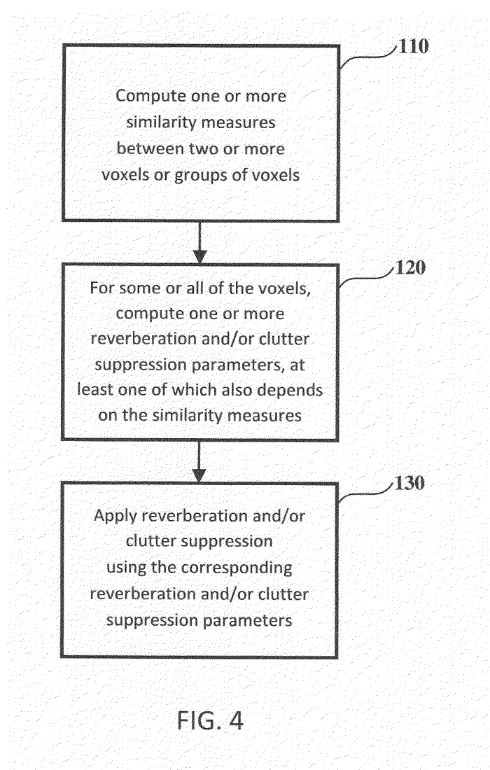

The reverberation and/or clutter suppression process may include the following steps, described in FIG. 4 (the “generalized reverberation and/or clutter suppression process”):

(a) Step 110—compute one or more similarity measures between two or more voxels or groups of voxels within a cine-loop or within a processed subset of the cine-loop, so as to assess their spatial and/or temporal self-similarity, wherein the processed subset of the cine-loop is defined by a set of entries into the scanned data array for all frames and/or for a set of the cine-loop frames and/or for a set of entries into the scanned data array for each of a set of frames.

(b) Step 120—for at least one of: (i) each voxels (ii) each group of adjacent voxels within the cine-loop or the processed subset of the cine-loop; and (iii) each group of voxels which are determined to be affected by reverberations and/or clutter (“reverberation and/or clutter affected voxels”), based on one or more criteria, at least one of which relates to the similarity measures computed in step 110,

compute one or more reverberation and/or clutter suppression parameters, at least one of which also depends on the similarity measures computed in step 110.

(c) Step 130—for at least one of: (i) each voxel; (ii) each group of adjacent voxels within the cine-loop or the processed subset of the cine-loop; and (iii) each group of voxels which are determined to be reverberation and/or clutter affected voxels, based on one or more criteria, at least one of which relates to the similarity measures computed in step 110, apply reverberation and/or clutter suppression using the corresponding reverberation and/or clutter suppression parameters.

Step 110 may further comprise a process of adaptive selection of the processed subset of the cine-loop.

The selection of the processed subset of the cine-loop may be based, for example, on image segmentation, looking for regions of interest using any method known in the art.

Additionally or alternatively, one may look for regions where there is significant potential for finding high spatial and/or temporal self-similarity. This may be done, for example, by looking for various image features, such as line segments, corners (two line segments intersecting at their ends), rectangles, ellipses and so forth, using any method known in the art. e.g., Hough transform. The presence of two or more such image features in a single frame, whose parameters are similar (disregarding spatial translation and/or rotation and/or mirror reversal), is indicative of potential spatial self-similarity. The presence of two or more such image features in two or more frames, whose parameters are similar (disregarding spatial translation and/or rotation and/or mirror reversal), is indicative of potential temporal self-similarity or spatial-temporal self-similarity. Therefore, the processed subset of the cine-loop may be defined using the following process:

(a) Initialize the processed subset of the cine-loop to be an empty group.

(b) Locate groups of features whose parameters are similar, disregarding spatial translation and/or rotation and/or mirror reversal (“feature groups”).

(c) For each feature in a feature group, a certain spatial and/or temporal region surrounding such feature should be added to the processed subset of the cine-loop (if it has not been added in a previous step).

In certain cases, the reverberation and/or clutter suppression process may be applied online, in any appropriate processing phases of scanner 22, e.g., either before or after each of the following processing steps:

(a) Filtration of the received signal using a filter matched to the transmitted waveform, so as to reduce thermal noise and decode compressed pulses.

(b) Down-conversion of the received signal, bringing its central frequency to an intermediate frequency or to the baseband.

(c) Gain corrections, such as overall gain control and time-gain control (TGC).

(d) Log-compression, i.e., computing the logarithm of the signal magnitude.

(e) Polar formatting, i.e., transforming the dataset to a Cartesian coordinate system.

The reverberation and/or clutter suppression process may also be applied offline, to pre-recorded cine-loops. The input to the reverberation and/or clutter suppression process may thus be real or complex, and the processing may be analog or digital.

The reverberation and/or clutter suppression processing per frame may be limited to the use of data for the currently acquired frame (“current frame”) and/or previously acquired frames (“previous frames”). This configuration applies, for example, to some cases of online processing, wherein at any given time scanner 22 only has information regarding the current frame and perhaps regarding previous frames. In other embodiments, the reverberation and/or clutter suppression processing for each frame may employ any frame within the cine-loop. This configuration applies, for example, to some offline processing methods.

In some aspects of the present invention, one or more of the following assumptions underlie the use of self-similarity measures for reverberation suppression:

(a) The inventor has discovered that in some ultrasound imaging applications, e.g., echocardiography, the temporal frequencies associated with reverberations are relatively low compared to the temporal frequencies associated with most non-reverberation echoes, wherein most non-reverberation echoes in echocardiography originate from organs such as the heart or the blood vessels. Temporal self-similarity between consecutive frames is thus expected to be indicative of reverberations (the “temporal self-similarity assumption”).

(b) Ghost images resulting from reverberations are expected to produce spatial self-similarities within an ultrasound frame (the “spatial self-similarity assumption”).

If the acoustic interface generating the multiple reflections is relatively large and continuous, one would expect it to produce specular reflections, that is, according to the law of reflection, the angle at which the wave is incident on the acoustic interface would be equal to the angle at which it is reflected. In such cases, the shape and location of the ghost images may be estimated by tracing the ultrasound waves from the probe to the acoustic interface generating the multiple reflections and then to the reflective object generating the ghost images (“ghost image estimation by ray-tracing”). The same technique may be employed for ghost images resulting from a higher number of reflections within the medium, which are also expected to be associated with lower signal energy, since the total attenuation within the medium tends to increase with the distance traversed within the medium. Ghost images may thus appear in scan lines wherein the spatial angle between the scan line and the acoustic interface generating the multiple reflections (at the point of incidence) equals the spatial angle between the acoustic interface generating the multiple reflections (at the point of incidence) and the direct line between the point of incidence on the acoustic interface generating the multiple reflections and the object generating the ghost image. The distance from the acoustic interface generating the multiple reflections (at the point of incidence) and the ghost image is expected to match the distance between that acoustic interface and the object generating the ghost image. The ghost image may be rotated and/or mirror-reversed with respect to the object generating it, and it may also be deformed according to the shape of the acoustic interface generating the multiple reflections (similar to mirror images in non-planar mirrors). Further deformation may result from the fact the system-wide point-spread function (PSF) of scanner 22 may change as a function of spatial location with respect to probe 26 and/or time.

If the interface generating the multiple reflections is small and distributed, the ghost image may also become hazy and smeared.

(c) In some cases, an object within the scanned region may have a ghost image appearing in two or more consecutive frames. In such cases, the motion of the object generating a ghost image and the corresponding ghost image are expected to be coordinated (the “spatial-temporal self-similarity assumption”).

When tracking an object and a candidate ghost image of that object in consecutive frames, detecting coordinated motion of the object and the candidate ghost image may be used to validate that the candidate ghost image is indeed a ghost image.

When tracking an object, a candidate ghost image of that object and an acoustic interface which may have been involved in generating the ghost image, detecting that the location of the candidate ghost image as a function of time matches the location of the object and the acoustic interface as a function of time may be used to validate that the candidate ghost image is indeed a ghost image.

Some of the aforementioned assumptions also apply to other types of clutter, and the use of self-similarity measures may thus be extended to such types of clutter as well. For example:

(a) Temporal self-similarity: In U.S. Pat. No. 8,045,777, issued on Oct. 25, 2011, titled “Clutter suppression in ultrasonic imaging systems.” Zwirn describes a method for ultrasonic imaging, wherein reflection is determined as associated with clutter if the local signal's de-correlation time is above a specified threshold. This method is applies, for example, to sidelobe clutter.

(b) Spatial self-similarity: Highly reflective objects in the probe's sidelobes may generate visible ghost images. The shape of these ghost images is expected to be similar to that of the objects that generate them, with some amplitude and/or phase variations and/or modulations resulting from the sidelobe pattern of probe 26. In polar and/or spherical coordinates, the spatial orientation of the ghost images is expected to be similar to that of the objects that generate them. Over time, this may also result in spatial-temporal self-similarity.

It should be emphasized that spatial and/or temporal self-similarity may result from reverberations and/or clutter, but it may also occur naturally within the scanned region. Therefore, the detection of reverberation and/or clutter artifacts may employ other criteria in addition to self-similarity.

### Utilizing Temporal Self-Similarity

Various exemplary embodiments of the invention, wherein the temporal self-similarity assumption may be employed for suppressing reverberation and/or clutter artifacts, are detailed hereon.

The reverberations and/or clutter may be reduced by way of temporal filtering, e.g., applying a high-pass and/or a band-pass filter, in accordance with the temporal self-similarity assumption. And/or the temporal frequency response of the filter or filters used may be predefined. The temporal frequency response may also be adaptively determined for each cine-loop and/or each frame and/or each spatial region.

The generalized reverberation and/or clutter suppression process may be employed, wherein computing one or more similarity measures in step 110 includes calculating one or more measures of temporal variability (low temporal variability corresponds to temporal self-similarity between consecutive frames) for each voxel in each frame and/or for a subset of the voxels in each frame and/or for all voxels in a subset of the frames and/or for a subset of the voxels in a subset of the frames, wherein the subset of the voxels may change between frames. In certain embodiments, spatial and/or temporal interpolation and/or extrapolation may be used to estimate the temporal variability for some or all of the voxels in some or all of the frames. Any temporal variability measure known in the art may be used, for example:

(a) The local ratio between the signal energy of the output of a temporal low-pass filter and the total signal energy (high values of this measure are indicative of low temporal variability);

(b) The local ratio between the signal energy of the output of a temporal low-pass filter and the signal energy of the output of a temporal band-pass or temporal high-pass filter (high values of this measure are indicative of low temporal variability);

(c) The local signal energy of the output of a temporal low-pass filter (high values of this measure may be indicative of low temporal variability);

(d) The local difference between the total signal energy and the signal energy of the output of a temporal low-pass filter (low values of this measure are indicative of low temporal variability); and

(e) The local difference between the signal energy of the output of a temporal low-pass filter and the signal energy of the output of a temporal band-pass or temporal high-pass filter, such difference may be positive, negative or equal 0 (high values of this measure are indicative of low temporal variability);

wherein the term “local” refers to a certain voxel or to a certain voxel and one or more adjacent voxels in the scanned data array. Note that when computing ratios, cases of “divide by zero” should be appropriately handled.

In certain cases, step 120 of the generalized reverberation and/or clutter suppression process may include the identification of reverberation and/or clutter affected voxels, wherein the identification of reverberation and/or clutter affected voxels may be performed for each cine-loop and/or each frame and/or each spatial region within the cine-loop and/or one or more spatial regions within each frame. In some embodiments, the identification of reverberation and/or clutter affected voxels may be based on comparing the one or more measures of temporal variability computed in step 110 to one or more corresponding thresholds (“identification thresholds”). When more than one measure of temporal variability is used, the identification of reverberation and/or clutter affected voxels may be performed by applying one or more logic criteria to the results of comparing the measures of temporal variability to the corresponding identification thresholds, e.g., by applying an AND or an OR operator between the results.

In some cases, the identification thresholds may be predefined, either as global thresholds or as thresholds which depend on the index of the entry into the scanned data array and/or on the frame index. In other embodiments, the identification thresholds may be adaptively determined for each cine-loop and/or each frame and/or each spatial region. The adaptive determination of the identification thresholds may be performed employing any method known in the art. For example, one may use the following technique, which assumes that the values of the temporal variability measure may be divided into two separate populations, one of which corresponds to reverberation and/or clutter affected voxels and the other to voxels substantially unaffected by reverberation and/or clutter:

(a) Select the set of voxels for which the identification threshold would be computed (the “identification threshold voxel set”), e.g., all voxels in the cine-loop, all voxels in a frame, a subset of the voxels in a specific frame or a subset of the voxels in a subset of the frames.

(b) Produce a list of the values of a temporal variability measure corresponding to the identification threshold voxel set, and sort this list in either ascending or descending order, to obtain the “sorted temporal variability measure list”.

(c) For each element of the sorted temporal variability measure list:
(i) Compute the mean value, m₁, for all elements whose index into the sorted temporal variability measure list is lower than (alternatively, whose index is lower than or equal to) the current element's index, and the mean value, m₂, for all elements whose index is higher than (alternatively, whose index is higher than or equal to) the current element's index;
(ii) Compute the sum of the squared differences, S₁, between the value of each element whose index is lower (alternatively, whose index is lower than or equal to) than the current element's index and the value of m₁;
(iii) Compute the sum of the squared differences, S₂, between the value of each element whose index is higher than (alternatively, whose index is higher than or equal to) the current element's index and the value of m₂.

(d) Set the identification threshold to the value of the temporal variability measure corresponding to the element of the sorted temporal variability measure list for which the value of S₁+S₂ is minimal.

Additionally or alternatively, one may also utilize the standard deviation operator instead of the sum of the squared differences operator in the above process. Another exemplary method for setting the identification threshold is using the Otso algorithm.

In even further cases, step 130 of the generalized reverberation and/or clutter suppression process may include applying a reverberation and/or clutter suppression operator to reverberation and/or clutter affected voxels, as determined by step 120. For example, at least one of the following operators may be employed:

(a) Set the signal value in reverberation and/or clutter affected voxels to a certain predefined constant, e.g., 0.

(b) Multiply the signal corresponding to reverberation and/or clutter affected voxels by a predefined constant, preferably between 0 and 1.

(c) Subtract a certain predefined constant from the signal corresponding to reverberation and/or clutter affected voxels.

(d) Apply a temporal high-pass or a temporal band-pass filter to reverberation and/or clutter affected voxels, so as to suppress the contribution of low temporal frequencies, in accordance with the temporal self-similarity assumption. The lower cut-off frequency of the filters may be set so as to attenuate or to almost nullify low-frequency content.

(e) Replace the signal value in reverberation and/or clutter affected voxels by a function of the signal levels in their immediate spatial and/or temporal vicinity, said function may be, for example, the mean, weighted mean or median value of the signal level in the immediate spatial and/or temporal vicinity.

In other cases, a reverberation and/or clutter suppression operator may be applied to all voxels or to a certain subset of the frames and/or voxels within such frames, rather than to reverberation and/or clutter affected voxels only, in which case identifying reverberation and/or clutter affected voxels may not be necessary. Some examples for applicable reverberation and/or clutter suppression parameters:

(a) A temporal variability measure or a function of two or more temporal variability measures.

(b) A function of (a), defined so that its values would range from 0 to 1, receiving a certain constant value (e.g. 0 or 1) for voxels which are substantially unaffected by reverberation and/or clutter and another constant (e.g., 1 or 0) for voxels which are strongly affected by reverberation and/or clutter. For example, one may use a sigmoid function.

$${P}_{rc} = {[ 1 + exp ( - \frac{{m}_{rc} - β}{α} ) ]}^{- 1} \qquad ( 1 )$$

wherein P_{rc} is the reverberation and/or clutter suppression parameter, m_{rc} is the temporal variability measure, β is a parameter defining the center of the sigmoid function, and α is a parameter defining the sigmoid function's width. This function yields the value 0.5 for m_{rc}=β, values close to 0 for m_{rc} values much lower than β, and values close to 1 for m_{rc} values much higher than β, wherein the width of the transient region depends on α. In some embodiments, β should correspond to the identification threshold for reverberation and/or clutter affected voxels, and ca should correspond to the error estimate of the threshold for reverberation and/or clutter affected voxel.

(c) The result of applying a spatial and/or a temporal low-pass filter, using any method known in the art, to the output of (a) or (b).

One or more of the following reverberation and/or clutter suppression operators may be used per processed voxel:

(a) Multiply the signal value by one or more reverberation and/or clutter suppression parameters.

(b) Multiply the signal value by a linear function of the one or more reverberation and/or clutter suppression parameters.

(c) Add to the signal value a linear function of the one or more reverberation and/or clutter suppression parameters.

(d) Apply a temporal high-pass filter or a temporal band-pass filter to the signal value, wherein the filter parameters depend on one or more reverberation and/or clutter suppression parameters. For example, subtract from the value of each voxel the output of a temporal low-pass filter (note that subtracting the output of a low-pass filter is equivalent to applying a high-pass filter) multiplied by a linear function of the one or more reverberation and/or clutter suppression parameters, so as to obtain full suppression effect for voxels which are strongly affected by reverberation and/or clutter, some suppression effect for voxels which are slightly or uncertainly affected by reverberation and/or clutter, and negligible suppression effect for voxels which are substantially unaffected by reverberation and/or clutter.

Utilizing Spatial Self-Similarity and/or Spatial-Temporal Self-Similarity

Various exemplary embodiments wherein the spatial self-similarity assumption and/or the spatial-temporal self-similarity assumption may be employed for suppressing reverberation and/or clutter artifacts are detailed hereon.

In some embodiments of the present invention, computing the one or more reverberation and/or clutter suppression parameters in step 120 includes detecting the one or more ghost voxels or groups of voxels (the “ghost patterns”) out of two or more similar voxels or groups of voxels (the “similar patterns”). In embodiments, the reverberation and/or clutter suppression parameters may then be set so as to suppress ghost patterns without affecting the remaining similar patterns (referred to as the “true patterns”).

In certain cases, at least one of the following parameters may be used to detect ghost patterns out of similar patterns (“ghost pattern parameters”):

(a) Mean signal magnitude and/or energy within each pattern and/or a subset of the voxels within each pattern—true patterns are expected to have higher mean signal magnitude and/or energy than the corresponding ghost patterns.

(b) Parameters derived from the spatial frequency distribution within each pattern and/or a subset of the voxels within each pattern, e.g., total energy in the output of a spatial high-pass filter, energy ratio between the outputs of a spatial high-pass filter and a spatial low-pass filter, energy ratio between the output of a spatial high-pass filter and the original pattern, standard deviation of the power spectrum and so forth. For example, physical artifacts within the medium such as refraction and scattering, as well as spatial dependence of the system-wide PSF of scanner 22, may cause ghost patterns to be slightly smeared versions of the corresponding true patterns, so that their high-frequency content may be lower than that of the corresponding true patterns. Additionally or alternatively, the sidelobe pattern of probe 26 may cause spatial amplitude and/or phase modulations within ghost patterns when compared to the corresponding true patterns, which may broaden the power spectrum, thus increasing the standard deviation of the power spectrum.

(c) Parameters relating to the information content within each pattern and/or a subset of the voxels within each pattern, e.g., according to the measured entropy. For instance, physical artifacts within the medium such as refraction and scattering, as well as spatial dependence of the system-wide PSF of scanner 22, may cause ghost patterns to be slightly smeared versions of the corresponding true patterns, so that the information content within ghost patterns may be lower than that within the corresponding true patterns.

(d) Parameters relating to the distribution of the signal and/or signal magnitude and/or signal energy within each pattern and/or a subset of the voxels within each pattern, e.g., standard deviation, skewness, maximum likelihood value, a certain percentile of the distribution, ratio between certain percentiles of the distribution and so on. For example, the sidelobe pattern of probe 26 may cause spatial amplitude and/or phase modulations within ghost patterns when compared to the corresponding true patterns, which may broaden the distribution of the signal and/or signal magnitude and/or signal energy within ghost patterns, thus increasing the standard deviation of the signal and/or magnitude and/or signal energy within ghost patterns and/or a subset of the voxels within ghost patterns compared to the corresponding true patterns.

In further cases, in step 120, the detection of one or more ghost patterns out of two or more similar patterns may also employ criteria based on whether one or more of the similar patterns may be a ghost of one or more of the other similar patterns given one or more detected acoustic interfaces (which may generate multiple reflections), according to ghost image estimation by ray-tracing. For example, one of the similar patterns may be detected as a ghost pattern if, according to ghost image estimation by ray-tracing, it may be a ghost of another of the similar patterns, and its mean signal magnitude and/or energy is lower.

Additionally or alternatively, certain embodiments further comprise artifact sources search, that is, searching for highly reflective elements within the image (“artifact sources”), which may produce discernible reverberation and/or clutter artifacts within one or more frames. Given the location of an artifact source, one may perform at least one of the following:

(a) For each artifact source, one may employ ghost image estimation by ray-tracing to assess the potential location of one or more ghosts of that artifact source which result from reverberations (the “artifact source ghost targets”). This process also entails the detection of one or more acoustic interfaces, which may be involved in producing ghost images.

(b) For each scan line, the contribution of the artifact sources to each range gate which results from sidelobe clutter may be estimated based on the probe's sidelobe pattern for that scan line.

The results of the artifact sources search may be employed, for instance, in step 110, for selecting the processed subset of the cine-loop For example, the processed subset of the cine-loop may include, for each frame, one or more artifact sources as well as one or more artifact source ghost targets.

The artifact sources may be selected by detecting continuous regions whose signal energy is relatively high, so that the energy of their ghosts would be substantial as well. One method of detecting such continuous regions is to apply a non-linear filter to one or more frames of the cine-loop, which produces high values for areas where both the mean signal energy is relatively high and the standard deviation of the signal energy is relatively low. Other methods may be based on applying an energy threshold to the signal within one or more frames to detect high energy peaks, and then employ region growing methods to each such high energy peak to produce the artifact sources.

Additionally or alternatively, the detection of artifact sources and/or of acoustic interfaces may be performed by any edge detection and/or segmentation method known in the art. For instance, one may use classic edge detection (see, for example, U.S. Pat. No. 6,716,175, by Geiser and Wilson, issued on Apr. 6, 2004, and titled “Autonomous boundary detection system for echocardiographic images”) or radial search techniques (see, for example. U.S. Pat. No. 5,457,754, by Han et al, issued on Oct. 10, 1095, and titled “Method for automatic contour extraction of a cardiac image”). Such techniques may be combined with knowledge-based algorithms, aimed at performance enhancement, which may either be introduced during post-processing, or as a cost-function, incorporated with the initial boundary estimation. Another example for an applicable segmentation method is solving a constrained optimization problem, based on active contour models (see, for example, a paper by Mishra et al., entitled “A GA based approach for boundary detection of left ventricle with echocardiographic image sequences,” Image and Vision Computing, vol. 21, 2003, pages 967-976, which is incorporated herein by reference).

Some embodiments of the invention further comprise tracking one or more patterns between two or more consecutive frames (“pattern tracking”). This may be done using any spatial registration method known in the art. In some cases, the spatial registration may be rigid, accounting for global translations and/or global rotation of the pattern. In other cases, the spatial registration may be non-rigid, also taking into account local deformations, which may occur over time. Note that in 2D imaging, even object which do not undergo deformation between two consecutive frames may still appear deformed due to out-of-plane motion, i.e., velocity vectors also having components along an axis perpendicular to the imaging plane.

The pattern tracking may be utilized in at least one of the following steps:

(a) In step 110, for selecting the processed subset of the cine-loop. For example, once the processed subset of the cine-loop has been defined for a given frame (the “subset reference frame”), the processed subset of the cine-loop in one or more of the following frames may be determined by pattern tracking for each voxel or group of voxels within the processed subset of the cine-loop for the subset reference frame.

(b) In step 120, the detection of one or more ghost patterns out of two or more similar patterns may also employ criteria based on the spatial-temporal self-similarity assumption. That is, one of the similar patterns (“similar pattern G”) is considered more likely to be a ghost of another of the similar patterns (“similar pattern G”) if the relative motion of the two patterns over consecutive frames follow certain criteria, such as one or more of the following criteria:
(i) The spatial distance traversed (between two or more consecutive frames) by the center of mass of each of similar pattern G and similar pattern O is approximately the same;
(ii) The distance traversed (between two or more consecutive frames) along one or more specific axes (e.g., along a certain axis parallel to the probe's surface) by the center of mass of each of similar pattern G and similar pattern O is approximately the same;
(iii) The angular rotation (between two or more consecutive frames) of similar pattern G and similar pattern O, with or without taking into account mirror reversal, is approximately the same;
(iv) The magnitude of the angular rotation (between two or more consecutive frames) of similar pattern G and similar pattern O, with or without taking into account mirror reversal, is approximately the same,
(v) The magnitude of the angular rotation (between two or more consecutive frames) of similar pattern G and similar pattern O, with or without taking into account mirror reversal, is approximately the same, but the angular rotations are in opposite directions; and
(vi) The angular rotation (between two or more consecutive frames) with respect to a specific axis (e.g., the rotation in azimuth in elevation) of similar pattern (and similar pattern O, with or without taking into account mirror reversal, is approximately the same.

In even further embodiments of the present invention, applying reverberation and/or clutter suppression in step 130 of the generalized reverberation and/or clutter suppression process may further comprise applying a reverberation and/or clutter suppression operator to reverberation and/or clutter affected voxels, as determined by step 120. For example, at least one of the following operators may be employed:

(a) Set the signal value in reverberation and/or clutter affected voxels to a certain predefined constant, e.g., 0.

(b) Multiply the signal corresponding to reverberation and/or clutter affected voxels by a predefined constant, preferably between 0 and 1.

(c) Subtract a certain predefined constant from the signal corresponding to reverberation and/or clutter affected voxels.

(d) Replace the signal value in reverberation and/or clutter affected voxels by a function of the signal levels in their immediate spatial and/or temporal vicinity, said function may be, for example, the mean, weighted mean or median value of the signal level in the immediate spatial and/or temporal vicinity.

(e) For each group of spatially and/or temporally adjacent reverberation and/or clutter affected voxels (“clutter affected voxel group”), compute at least one of the following inter-voxel group parameters:
(i) The ratio (“voxel group ratio”) between the value of a certain statistic of the signal and/or the signal magnitude and/or the signal energy and/or the signal videointensity within the group and within the corresponding group of voxels within the corresponding true pattern (“true pattern voxel group”), wherein the statistic may be, for example, the mean, median, maximum, certain predefined percentile maximum likelihood and so on;
(ii) The relative angular rotation between the true pattern voxel group and the clutter affected voxel group (“voxel group angular rotation”), using any registration technique known in the art, with or without taking into account mirror reversal; and
(iii) The PSF that would approximately produce the clutter affected voxel group from the true pattern voxel group (“voxel group PSF”), wherein the PSF may be estimated after correcting for the voxel group ratio and/or applying mirror reversal and/or rotating the clutter affected voxel group to match the true pattern voxel group (or vise versa).

After computing at least one of the inter-voxel group parameters, apply these parameters to the true pattern voxel group (i.e., multiply the true pattern voxel group by the voxel group ratio, and/or rotate the true pattern voxel group by the voxel group angular rotation, with or without mirror reversal, and/or apply the voxel group PSF to the true pattern voxel group), and subtract the result multiplied by a certain constant, e.g., 1.0, from the clutter affected voxel group.

In other cases, reverberation and/or clutter suppression may be applied to all voxels or to a certain subset of the frames and/or voxels within such frames, rather than to reverberation and/or clutter affected voxels only. Some examples for applicable reverberation and/or clutter suppression parameters are:

(a) A similarity measure or a function or two or more similarity measures.

(b) Parameters indicative of the probability for a voxel or a group of voxels to be reverberation and/or clutter affected voxels. The values of such parameters should increase with at least one of the following:
(i) The value of one or more similarity measures (whose value increases with greater similarity) between the pattern to which the current voxel or group of voxels belong (the “current pattern”) and another pattern within the cine-loop increases;
(ii) The value of one or more similarity measures (whose value decreases with greater similarity) between the pattern to which the current voxel or group of voxels belong (the “current pattern”) and another pattern within the cine-loop decreases; and
(iii) Out of the group of patterns similar to the current pattern, including the current pattern itself, the current pattern is most likely to be a ghost pattern, based on ghost pattern parameters and/or on ghost image estimation by ray-tracing.

(c) A function of (a) and/or of (b), defined so that its values would range from 0 to 1, receiving a certain constant (e.g., 0 or 1) for voxels which are substantially unaffected by reverberation and/or clutter and another constant (e.g., 1 or 0) for voxels which are strongly affected by reverberation and/or clutter. For example, one may use a sigmoid function, as described in Eq. 1.

(d) The result of applying a spatial and/or a temporal low-pass filter, using any method known in the art, to (a) or (b) or (c).

In embodiments, one or more of the following reverberation and/or clutter suppression operators may be used per processed voxel:

(a) Multiply the signal value by one or more reverberation and/or clutter suppression parameters.

(b) Multiply the signal value by a linear function of the one or more reverberation and/or clutter suppression parameters.

(c) Add to the signal value a linear function of the one or more reverberation and/or clutter suppression parameters.

1. A method for clutter suppression in ultrasonic imaging, said method comprising:
transmitting an ultrasonic radiation towards a target medium via a probe;
receiving reflections of the ultrasonic radiation from said target medium in a reflected signal via a scanner, wherein the reflected signal is spatially arranged in a scanned data array, which may be one-, two-, or three-dimensional, so that each entry into the scanned data array corresponds to a pixel or a volume pixel (either pixel or volume pixel being collectively a “voxel”), and wherein the reflected signal may also be divided into frames, each of which corresponding to a specific timeframe is a cine-loop:
the method including the following steps:
step 110—computing one or more self-similarity measures between two or more voxels or groups of voxels within a cine-loop or within a processed subset of the cine-loop, so as to assess their self-similarity;
step 120—for at least one of: (i) each voxel; (ii) each group of adjacent voxels within the cine-loop or the processed subset of the cine-loop, and (iii) each group of voxels which are determined to be affected by clutter, based on one or more criteria, at least one of which relates to the self-similarity measures computed in step 110, computing one or more clutter parameters, at least one of which also depends on the self-similarity measures computed in step 110; and
step 130—for at least one of: (i) each voxel; (ii) each group of adjacent voxels within the cine-loop or the processed subset of the cine-loop; and (iii) each group of voxels which are determined to be clutter affected voxels, based on one or more criteria, at least one of which relates to the self-similarity measures computed in step 110,
applying clutter suppression using the corresponding suppression parameters.

2. The method of claim 1, wherein in step 110, the processed subset of the cine loop is defined by at least one of:
(a) a set of entries into the scanned data array for all frames;
(b) a set of entries into the scanned data array for a set of the cine loop frames; and
(c) sets of entries into the scanned data array for each of a set of frames.

3. The method of claim 1, wherein said clutter is at least one of:
(a) reverberation; and
(b) sidelobe clutter.

4. The method of claim 1, wherein the self-similarity is at least one of:
(a) spatial self-similarity; and
(b) temporal self-similarity.

5. The method of claim 1, wherein multiple reflected signals are received from the target medium, wherein each reflected signal corresponds to a different receive beam of probe, and wherein each reflected signal is being processed by the method of claim 1 separately.

6. The method of claim 1, wherein:
(a) Two or more groups of voxels, corresponding to different sets of entries into the scanned data array and/or to different frames, are similar if the signal pattern within the two or more groups of voxels is similar, either in their original spatial orientation or after applying spatial rotation and/or mirror reversal, the reversal of the signal pattern along a certain axis; and/or
(b) Two or more signal patterns are considered similar if the “signal ratio” between most or all of the pairs of voxels within one pattern is similar to the “signal ratio” of the corresponding pairs of voxels in the other patterns, wherein the term “signal ratio” refers to one of: (i) the ratio of the measured signals; (ii) the ratio of the magnitudes of the measured signals; (iii) the energy ratio of the measured signals; or (iv) the ratio of video intensities of the corresponding voxels.

7. The method of claim 1, wherein step 110 further comprises a process of adaptive selection of the processed subset of the cine-loop; wherein the processed subset of the cine-loop is based on image segmentation, looking for regions of interest; and wherein the processed subset of the cine-loop is defined using the following process:
(a) Initialize the processed subset of the cine-loop to be an empty group;
(b) Locate groups of image features whose parameters are similar (“feature groups”), wherein the location of feature groups either takes into account or disregards spatial translation and/or rotation and/or mirror reversal; and
(c) For each feature in a feature group, a certain spatial and/or temporal region surrounding such feature either is or is not added to the processed subset of the cine-loop.

8. The method of claim 1, wherein the input to the reverberation and/or clutter suppression method is real or complex, and the processing is analog or digital, and wherein the reverberation and/or clutter suppression method may be applied in at least one of the following ways:
(a) Online, in any appropriate processing phases of scanner 22, either before or after each of the following processing steps:
(i) Filtration of the received signal using a filter matched to the transmitted waveform, to thereby reduce thermal noise and decode compressed pulses;
(ii) Down-conversion of the received signal, thereby bringing its central frequency to an intermediate frequency or to the baseband;
(iii) Gain corrections, such as overall gain control and time-gain control (TGC);
(iv) Log-compression, thereby computing the logarithm of the signal magnitude; and
(v) Polar formatting, thereby transforming the dataset to a Cartesian coordinate system; and
(b) Offline, to pre-recorded cine-loops.

9. The method of claim 1, wherein the reverberation and/or clutter suppression processing per frame is one of:
(a) Limited to the use of data for the currently acquired frame (“current frame”) and/or previously acquired frames (“previous frames”), this configuration applying to cases of online processing, wherein at any given time scanner 22 only has information regarding the current frame and/or regarding previous frames; or
(b) Employs any frame within the cine-loop, this configuration applying to cases of offline processing methods.

10. The method of claim 1, wherein the reverberation and/or clutter suppression method employs a high-pass and/or a band-pass filter, in accordance with a temporal self-similarity assumption regarding reverberation and/or clutter artifacts, wherein the temporal frequency response of the filter or filters used is predefined, and/or the temporal frequency response is adaptively determined for each cine-loop and/or each frame and/or each spatial region.

11. The method of claim 1, wherein computing one or more similarity measures in step 110 includes: calculating one or more measures of temporal variability for each voxel in each frame; and/or for a subset of the voxels in each frame; and/or for all voxels in a subset of the frames; and/or for a subset of the voxels in a subset of the frames, wherein the subset of the voxels changes or does not change between frames.

12. The method of claim 11, wherein the temporal variability measure is selected from one of the following:
(a) The local ratio between the signal energy of the output of a temporal low-pass filter and the total signal energy, wherein high values of said measure are indicative of low temporal variability;
(b) The local ratio between the signal energy of the output of a temporal low-pass filter and the signal energy of the output of a temporal band-pass or temporal high-pass filter, wherein high values of said measure are indicative of low temporal variability;
(c) The local signal energy of the output of a temporal low-pass filter, wherein high values of said measure are indicative of low temporal variability;
(d) The local difference between the total signal energy and the signal energy of the output of a temporal low-pass filter, wherein low values of said measure are indicative of low temporal variability; and
(e) The local difference between the signal energy of the output of a temporal low-pass filter and the signal energy of the output of a temporal band-pass or temporal high-pass filter, such difference may be positive, negative or equal 0, wherein high values of this measure are indicative of low temporal variability,
wherein the term “local” refers to a certain voxel or to a certain voxel and one or more adjacent voxels in the scanned data array.

13. The method of claim 11, wherein the identification of reverberation and/or clutter affected voxels is based on comparing the one or more measures of temporal variability computed in step 110 to one or more corresponding thresholds (“identification thresholds”), and when more than one measure of temporal variability is used, the identification of reverberation and/or clutter affected voxels is performed by applying one or more logic criteria to the results of comparing the measures of temporal variability to the corresponding identification thresholds, by applying an AND and/or an OR and/or a XOR and/or a NOT operator between the results.

14. The method of claim 1, wherein step 120 includes the identification of reverberation and/or clutter affected voxels, wherein the identification of reverberation and/or clutter affected voxels is performed for each cine-loop and/or each frame and/or each spatial region within the cine-loop and/or one or more spatial regions within each frame.

15. The method of claim 13, wherein each of the identification thresholds is one of:
(a) Predefined, either as a global threshold or as a threshold which depends on the index of the entry into the scanned data array and/or on the frame index; or
(b) Adaptively determined for each cine-loop and/or each frame and/or each spatial region.

16. The method of claim 15, wherein the adaptive determination of the identification thresholds is performed employing the following method, wherein there is an assumption that the values of the temporal variability measure values are divided into two separate populations, one of which corresponds to reverberation and/or clutter affected voxels and the other to voxels substantially unaffected by reverberation and/or clutter, said method comprising the following steps:
(a) Select the set of voxels for which the identification threshold would be computed (the “identification threshold voxel set”);
(b) Produce a list of the values of a temporal variability measure corresponding to the identification threshold voxel set, and sort this list in either ascending or descending order, to obtain the “sorted temporal variability measure list”;
(c) For each element of the sorted temporal variability measure list:
(i) Compute the mean value, m₁, for all elements whose index into the sorted temporal variability measure list is lower than (alternatively, whose index is lower than or equal to) the current element's index, and the mean value, m₂, for all elements whose index is higher than (alternatively, whose index is higher than or equal to) the current element's index;
(ii) Compute the sum of the squared differences, S₁, between the value of each element whose index is lower (alternatively, whose index is lower than or equal to) than the current element's index and the value of m₁;
(iii) Compute the sum of the squared differences, S₂, between the value of each element whose index is higher than (alternatively, whose index is higher than or equal to) the current element's index and the value of m₂; and
(d) Set the identification threshold to the value of the temporal variability measure corresponding to the element of the sorted temporal variability measure list for which the value of S₁+S₂ is minimal.

17. The method of claim 14, wherein the identification of reverberation and/or clutter affected voxels is based on comparing the one or more measures of temporal variability computed in step 110 to one or more corresponding thresholds (“identification thresholds”), wherein the identification thresholds are adaptively determined for each cine-loop and/or each frame and/or each spatial region, wherein there is an assumption that the values of the temporal variability measure values are divided into two separate populations, one of which corresponds to reverberation and/or clutter affected voxels and the other to voxels substantially unaffected by reverberation and/or clutter, and wherein the adaptive determination of the identification thresholds is performed employing the following steps:
(a) Select the set of voxels for which the identification threshold would be computed (the “identification threshold voxel set”);
(b) Produce a list of the values of a temporal variability measure corresponding to the identification threshold voxel set, and sort this list in either ascending or descending order, to obtain the “sorted temporal variability measure list”;
(c) For each element of the sorted temporal variability measure list:
(i) Compute the mean value, m₁, for all elements whose index into the sorted temporal variability measure list is lower than (alternatively, whose index is lower than or equal to) the current element's index, and the mean value, m₂, for all elements whose index is higher than (alternatively, whose index is higher than or equal to) the current element's index;
(ii) Compute the sum of the squared differences, S₁, between the value of each element whose index is lower (alternatively, whose index is lower than or equal to) than the current element's index and the value of m₁;
(iii) Compute the sum of the squared differences, S₂, between the value of each element whose index is higher than (alternatively, whose index is higher than or equal to) the current element's index and the value of m₂; and
(d) Set the identification threshold to the value of the temporal variability measure corresponding to the element of the sorted temporal variability measure list for which the value of S₁+S₂ is minimal.

18. The method of claim 1, wherein step 130 includes applying a reverberation and/or clutter suppression operator to reverberation and/or clutter affected voxels, as determined by step 120, wherein, at least one of the following suppression operators is employed:
(a) Set the signal value in reverberation and/or clutter affected voxels to a certain predefined constant;
(b) Multiply the signal corresponding to reverberation and/or clutter affected voxels by a predefined constant, preferably between 0 and 1;
(c) Subtract a certain predefined constant from the signal corresponding to reverberation and/or clutter affected voxels;
(d) Apply a temporal high-pass or a temporal band-pass filter to reverberation and/or clutter affected voxels, so as to suppress the contribution of low temporal frequencies, the lower cut-off frequency of the filters being set so as to attenuate or to almost nullify low-frequency content; and
(e) Replace the signal value in reverberation and/or clutter affected voxels by a function of the signal levels in their immediate spatial and/or temporal vicinity, said function being: the mean; weighted mean; or median value of the signal level in the immediate spatial and/or temporal vicinity.

19. The method of claim 1, where applicable reverberation and/or clutter suppression parameters are one or more of the following:
(a) A temporal variability measure or a function of two or more temporal variability measures;
(b) A function of (a), defined so that its values range from 0 to 1, receiving a certain constant value for voxels which are substantially unaffected by reverberation and/or clutter and another constant for voxels which are strongly affected by reverberation and/or clutter;
(c) A Sigmoid function of (a):
$${P}_{rc} = {[ 1 + exp ( - \frac{{m}_{rc} - β}{α} ) ]}^{- 1}$$
wherein P_{rc} is the reverberation and/or clutter suppression parameter, m_{rc} is the temporal variability measure, β is a parameter defining the center of the Sigmoid function, and α is a parameter defining the Sigmoid function's width, wherein β corresponds to the identification threshold for reverberation and/or clutter affected voxels, and α corresponds to the error estimate of the threshold for reverberation and/or clutter affected voxel; and
(d) The result of applying a spatial and/or a temporal low-pass filter, to the output of (a) or (b) or (c).

20. The method of claim 1, wherein one or more of the following reverberation and/or clutter suppression operators are used in step 130 per processed voxel:
(a) Multiply the signal value by one or more reverberation and/or clutter suppression parameters;
(b) Multiply the signal value by a linear function of the one or more reverberation and/or clutter suppression parameters;
(c) Add to the signal value a linear function of the one or more reverberation and/or clutter suppression parameters; and
(d) Apply a temporal high-pass filter or a temporal band-pass filter to the signal value, wherein the filter parameters depend on one or more reverberation and/or clutter suppression parameters.

21. The method of claim 1, wherein computing the one or more reverberation and/or clutter suppression parameters in step 120 includes detecting one or more ghost voxels or groups of voxels resulting from reverberation and/or clutter artifacts (the “ghost patterns”) out of two or more similar voxels or groups of voxels (the “similar patterns”), said reverberation and/or clutter suppression parameters then being set so as to suppress ghost patterns without affecting the remaining similar patterns (the “true patterns”).

22. The method of claim 21, wherein at least one of the following parameters is used to detect ghost patterns out of similar patterns (“ghost pattern parameters”):
(a) Mean signal magnitude and/or energy within each pattern and/or a subset of the voxels within each pattern;
(b) Parameters derived from the spatial frequency distribution within each pattern and/or a subset of the voxels within each pattern;
(c) Parameters relating to the information content within each pattern and/or a subset of the voxels within each pattern; and
(d) Parameters relating to the distribution of the signal and/or signal magnitude and/or signal energy within each pattern and/or a subset of the voxels within each pattern.

23. The method of claim 21, wherein, in step 120, the detection of one or more ghost patterns out of two or more similar patterns also employs criteria based on whether one or more of the similar patterns is a ghost of one or more of the other similar patterns given one or more detected acoustic interfaces according to ghost image estimation by ray-tracing.

24. The method of claim 23, further comprising artifact sources search, and given the location of an artifact source, performing at least one of the following:
(a) For each artifact source, employing ghost image estimation by ray-tracing to assess the potential location of one or more ghosts of that artifact source which result from reverberations (the “artifact source ghost targets”); or
(b) For each scan line, estimating the contribution of the artifact sources to each range gate which results from sidelobe clutter, based on the sidelobe pattern of probe 26 for that scan line.

25. The method of claim 24, wherein the results of the artifact sources search are employed in step 110, for selecting the processed subset of the cine-loop, said processed subset of the cine-loop including, for each frame, at least one of: (i) one or more artifact sources; and (ii) one or more artifact source ghost targets.

26. The method of claim 24, wherein the artifact sources are selected by detecting continuous regions whose signal energy is relatively high.

27. The method of claim 26, wherein detecting continuous regions includes at least one of:
(a) Applying a non-linear filter to one or more frames of the cine-loop, said non-linear filter producing high values for areas where both the mean signal energy is relatively high and the standard deviation of the signal energy is relatively low; and/or
(b) Applying an energy threshold to the signal within one or more frames to detect high energy peaks, and then employing region growing methods to each such high energy peak to produce the artifact sources.

28. The method of claim 24, wherein the detection of artifact sources and/or of acoustic interfaces is performed by an edge detection and/or segmentation process.

29. The method of claim 1, further comprising:
tracking one or more patterns between two or more consecutive frames (“pattern tracking”), using a spatial registration method, said pattern tracking being utilized in at least one of the following steps:
(a) In step 110, for selecting the processed subset of the cine-loop, wherein, once the processed subset of the cine-loop has been defined for a given frame (the “subset reference frame”), the processed subset of the cine-loop in one or more of the following frames is determined by pattern tracking for each voxel or group of voxels within the processed subset of the cine-loop for the subset reference frame;
(b) In step 120, the detection of one or more ghost patterns out of two or more similar patterns also employs criteria based on the assumption that one of the similar patterns (“similar pattern G”) is considered more likely to be a ghost of another of the similar patterns (“similar pattern O”) if the relative motion of the two patterns over consecutive frames follow certain criteria, such as one or more of the following criteria:
(i) The spatial distance traversed (between two or more consecutive frames) by the center of mass of each of similar pattern G and similar pattern O is approximately the same;
(ii) The distance traversed (between two or more consecutive frames) along one or more specific axes by the center of mass of each of similar pattern G and similar pattern O is approximately the same;
(iii) The angular rotation (between two or more consecutive frames) of similar pattern G and similar pattern O, with or without taking into account mirror reversal, is approximately the same;
(iv) The magnitude of the angular rotation (between two or more consecutive frames) of similar pattern G and similar pattern O, with or without taking into account mirror reversal, is approximately the same;
(v) The magnitude of the angular rotation (between two or more consecutive frames) of similar pattern G and similar pattern O, with or without taking into account mirror reversal, is approximately the same, but the angular rotations are in opposite directions; and
(vi) The angular rotation (between two or more consecutive frames) with respect to a specific axis of similar pattern G and similar pattern O, with or without taking into account mirror reversal, is approximately the same.

30. The method of claim 1, wherein step 130 further comprises applying a reverberation and/or clutter suppression operator to reverberation and/or clutter affected voxels, as determined by step 120, wherein at least one of the following operators is employed:
(a) Set the signal value in reverberation and/or clutter affected voxels to a certain predefined constant;
(b) Multiply the signal corresponding to reverberation and/or clutter affected voxels by a predefined constant, preferably between 0 and 1;
(c) Subtract a certain predefined constant from the signal corresponding to reverberation and/or clutter affected voxels;
(d) Replace the signal value in reverberation and/or clutter affected voxels by a function of the signal levels in their immediate spatial and/or temporal vicinity, said function may be, for example, the mean, weighted mean or median value of the signal level in the immediate spatial and/or temporal vicinity; and
(e) For each group of spatially and/or temporally adjacent reverberation and/or clutter affected voxels (“clutter affected voxel group”), compute at least one of the following inter-voxel group parameters:
(i) The ratio (“voxel group ratio”) between the value of a certain statistic of the signal and/or the signal magnitude and/or the signal energy and/or the signal videointensity within the group and within the corresponding group of voxels within the corresponding true pattern (“true pattern voxel group”), wherein the statistic may be, for example, the mean, median, maximum, certain predefined percentile, maximum likelihood;
(ii) The relative angular rotation between the true pattern voxel group and the reverberation and/or clutter affected voxel group (“voxel group angular rotation”), using any registration technique known in the art, with or without taking into account mirror reversal; and
(iii) The point spread function (PSF) that would approximately produce the clutter affected voxel group from the true pattern voxel group (“voxel group PSF”), wherein the PSF may be estimated after correcting for the voxel group ratio and/or applying mirror reversal and/or rotating the clutter affected voxel group to match the true pattern voxel group (or vise versa).

31. The method of claim 30, wherein after computing at least one of the inter-voxel group parameters, applying these parameters to the true pattern voxel group, by multiplying the true pattern voxel group by the voxel group ratio, and/or rotating the true pattern voxel group by the voxel group angular rotation, with or without mirror reversal, and/or applying the voxel group PSF to the true pattern voxel group, and subtracting the result multiplied by a certain constant, from the clutter affected voxel group.

32. The method of claim 1, wherein each of the one or more reverberation and/or clutter suppression parameters is at least one of:
(a) A similarity measure or a function or two or more similarity measures;
(b) A parameter indicative of the probability for a voxel or a group of voxels to be reverberation and/or clutter affected voxels. The values of such parameters should increase with at least one of the following:
(i) The value of one or more similarity measures (whose value increases with greater similarity) between the pattern to which the current voxel or group of voxels belong (the “current pattern”) and another pattern within the cine-loop increases;
(ii) The value of one or more similarity measures (whose value decreases with greater similarity) between the pattern to which the current voxel or group of voxels belong (the “current pattern”) and another pattern within the cine-loop decreases; and
(iii) Out of the group of patterns similar to the current pattern, including the current pattern itself, the current pattern is most likely to be a ghost pattern, based on ghost pattern parameters and/or on ghost image estimation by ray-tracing;
(c) A function of (a) and/or of (b), defined so that its values would range from 0 to 1, receiving a certain constant for voxels which are substantially unaffected by reverberation and/or clutter and another constant for voxels which are strongly affected by reverberation and/or clutter; and
(d) The result of applying a spatial and/or a temporal low-pass filter, using any method known in the art, to (a) or (b) or (c).

33. The method of claim 1, wherein one or more of the following reverberation and/or clutter suppression operators are used in step 130 per processed voxel:
(a) Multiply the signal value by one or more reverberation and/or clutter suppression parameters;
(b) Multiply the signal value by a linear function of the one or more reverberation and/or clutter suppression parameters; and
(c) Add to the signal value a linear function of the one or more reverberation and/or clutter suppression parameters.
